(19) United States
(12) Patent Application Publication
(10) Pub. No.: US 2010/0146968 A1
(43) Pub. Date: Jun. 17, 2010

(54) EMISSION SYSTEM, APPARATUS, AND METHOD

(76) Inventors: Alexander Simpson, Munich (DE); Rodrigo Rodriguez Erdmenger, Munchen (DE)

Correspondence Address: GENERAL ELECTRIC COMPANY;GLOBAL RESEARCH, ONE RESEARCH CIRCLE, PATENT DOCKET RM. BLDG. K1-4A59, NISKAYUNA, NY, 12309, US

(21) Appl. No.: 12/333,886

(22) Filed: Dec. 12, 2008

(51) Int. Cl. F02M 25/07; F02B 33/34; F01D 15/10; F02B 47/08

(52) U.S. Cl. 60/605.2; 123/568.2; 290/52

(57) ABSTRACT

A system, apparatus, and method for exhaust gas recirculation (EGR) is disclosed. The EGR apparatus includes an EGR circuit having an input configured to receive an exhaust gas from an engine exhaust port, an output configured to return the exhaust gas to an intake port of the engine, and an EGR path configured to circulate the exhaust gas between the input and the output. The EGR apparatus also includes an EGR compressor connected to the EGR circuit in the EGR path downstream of the input and EGR compressor configured to compress the exhaust gas for circulation to the output. The EGR apparatus further includes a valve system positioned in the EGR circuit and upstream of the EGR compressor to selectively cut off a flow of the exhaust gas to the EGR compressor and selectively inject ambient air into the EGR path.

### BACKGROUND

1. Technical Field

The invention includes embodiments that relate to an engine exhaust emission reduction system. Embodiments of the invention relate to vehicles, locomotives, generators, and the like. Embodiments of the invention relate to a method of controlling engine exhaust system emissions.

2. Discussion of Art

Production of emissions from mobile and stationary combustion sources such as locomotives, vehicles, power plants, and the like, contribute to environmental pollution. One particular source of such emissions are nitric oxides (NOₓ), such as NO or NO₂, emissions from vehicles, locomotives, generators, and the like. Environmental legislation restricts the amount of NOₓ that can be emitted by vehicles. In order to comply with this legislation, exhaust gas recirculation (EGR) system have been implemented to reduce the amount of NOₓ emissions. However, existing EGR systems are limited in their design and efficiency for operation of the combustion sources under various operating conditions.

As such, it may be desirable to have a system that has aspects and features that differ from those that are currently available. Further, it may be desirable to have a method that differs from those methods that are currently available.

### BRIEF DESCRIPTION OF THE INVENTION

Aspects of the invention provide an exhaust gas recirculation (EGR) apparatus including an EGR circuit having an input configured to receive an exhaust gas from an engine exhaust port, an output configured to return the exhaust gas to an intake port of the engine, and an EGR path configured to circulate the exhaust gas between the input and the output. The EGR apparatus also includes an EGR compressor connected to the EGR circuit in the EGR path downstream of the input and EGR compressor configured to compress the exhaust gas for circulation to the output. The EGR apparatus further includes a valve system positioned in the EGR circuit and upstream of the EGR compressor to selectively cut off a flow of the exhaust gas to the EGR compressor and selectively inject ambient air into the EGR path.

Aspects of the invention also provide an engine system that includes an engine having an intake manifold and an exhaust manifold, an exhaust conduit connected to the exhaust manifold to convey an exhaust gas away from the engine, and a turbocharger having a turbine and a compressor driven by the turbine, wherein the turbine is connected to the exhaust conduit to receive the exhaust gas from the exhaust manifold and wherein the compressor is positioned upstream of, and connected to, the intake manifold. The engine system also includes an exhaust gas recirculation (EGR) system connected to the exhaust conduit to receive at least a portion of the exhaust gas from the exhaust conduit. The EGR system includes an EGR conduit connected to the exhaust conduit to receive the at least a portion of the exhaust gas, a valve system positioned in the EGR conduit to control a flow of the at least a portion of the exhaust gas through the EGR conduit and selectively inject ambient air into the EGR conduit, and an EGR compressor connected to the EGR conduit downstream of the valve system and configured to selectively operate as a supercharger based on an orientation of the valve system.

Aspects of the invention also provide a method that includes the steps of conveying exhaust gas from an exhaust manifold of an internal combustion engine to an exhaust gas recirculation (EGR) system, selectively terminating a flow of the exhaust gas through the EGR system at a location upstream from an EGR compressor in the EGR system, and selectively injecting ambient air into the EGR system at a location upstream from the EGR compressor in the EGR system. The method also includes the steps of selectively transferring one of the exhaust gas and the ambient air to the EGR compressor, compressing the one of the exhaust gas and the ambient air to a desired pressure in the EGR compressor, and recirculating the compressed one of the exhaust gas and the ambient air to an intake manifold of the internal combustion engine.

Various other features may be apparent from the following detailed description and the drawings.

### BRIEF DESCRIPTION OF THE DRAWINGS

The drawings illustrate at least one preferred embodiment presently contemplated for carrying out the invention.

In the drawings:

FIG. 1 is a schematic diagram of an internal combustion engine system incorporating an exhaust gas recirculation (EGR) system according to an embodiment of the invention.

FIG. 2 is another schematic diagram of an internal combustion engine system incorporating an EGR system according to an embodiment of the invention.

### DETAILED DESCRIPTION

The invention includes embodiments that relate to exhaust gas recirculation (EGR) systems. The invention includes embodiments that relate to an apparatus for recirculation of exhaust gas. The invention includes embodiments that relate to a method of recirculating of exhaust gas.

Embodiments of the invention provide an exhaust gas recirculation (EGR) apparatus including an EGR circuit having an input configured to receive an exhaust gas from an engine exhaust port, an output configured to return the exhaust gas to an intake port of the engine, and an EGR path configured to circulate the exhaust gas between the input and the output. The EGR apparatus also includes an EGR compressor connected to the EGR circuit in the EGR path downstream of the input and EGR compressor configured to compress the exhaust gas for circulation to the output. The EGR apparatus further includes a valve system positioned in the EGR circuit and upstream of the EGR compressor to selectively cut off a flow of the exhaust gas to the EGR compressor and selectively inject ambient air into the EGR path.

Embodiments of the invention provide an engine system that includes an engine having an intake manifold and an exhaust manifold, an exhaust conduit connected to the exhaust manifold to convey an exhaust gas away from the engine, and a turbocharger having a turbine and a compressor driven by the turbine, wherein the turbine is connected to the exhaust conduit to receive the exhaust gas from the exhaust manifold and wherein the compressor is positioned upstream of, and connected to, the intake manifold. The engine system also includes an exhaust gas recirculation (EGR) system connected to the exhaust conduit to receive at least a portion of the exhaust gas from the exhaust conduit. The EGR system includes an EGR conduit connected to the exhaust conduit to receive the at least a portion of the exhaust gas, a valve system positioned in the EGR conduit to control a flow of the at least a portion of the exhaust gas through the EGR conduit and selectively inject ambient air into the EGR conduit, and an EGR compressor connected to the EGR conduit downstream of the valve system and configured to selectively operate as a supercharger based on an orientation of the valve system.

Embodiments of the invention provide a method that includes the steps of conveying exhaust gas from an exhaust manifold of an internal combustion engine to an exhaust gas recirculation (EGR) system, selectively terminating a flow of the exhaust gas through the EGR system at a location upstream from an EGR compressor in the EGR system, and selectively injecting ambient air into the EGR system at a location upstream from the EGR compressor in the EGR system. The method also includes the steps of selectively transferring one of the exhaust gas and the ambient air to the EGR compressor, compressing the one of the exhaust gas and the ambient air to a desired pressure in the EGR compressor, and recirculating the compressed one of the exhaust gas and the ambient air to an intake manifold of the internal combustion engine.

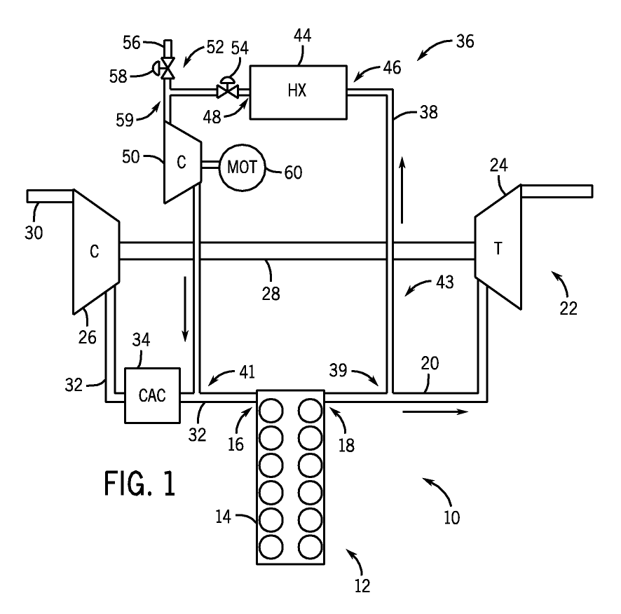

Referring to FIG. 1, a schematic illustration of an internal combustion engine system generally designated 10 is illustrated. The internal combustion engine system includes both mobile applications (e.g., automobiles, locomotives) and stationary applications (e.g., power plants). For ease in discussion, the internal combustion engine system 10 is discussed hereinafter in relation to a compression ignition engine system with the understanding that the discussion can readily be applied to other systems (e.g., systems that employ both spark ignition and compression ignition). The internal combustion engine system 10 comprises an engine 12, which includes an engine body 14, an air intake manifold 16, and an exhaust manifold 18. The air intake manifold 16 serves to deliver intake air (e.g., an oxygen-containing gas) to combustion chambers (e.g., cylinders) in the engine body 14 via intake valves (not shown). That is, the intake manifold 16 is connected with the combustion chambers to deliver intake air thereto. During operation, a fuel from a fuel source (not shown) is introduced into the combustion chambers. The type of fuel varies depending on the application. However, suitable fuels include hydrocarbon fuels such as gasoline, diesel, ethanol, methanol, kerosene, jet fuel, and the like; gaseous fuels, such as natural fluid, propane, butane, and the like; and alternative fuels, such as hydrogen, biofuels, dimethyl ether, synthetic fuels, and the like; as well as combinations comprising at least one of the foregoing fuels. The fuel is then combusted with the oxygen-containing gas to generate power.

The exhaust manifold 18 of the engine 12 is connected with the combustion chambers and serves to collect the exhaust gases generated by the engine 12. The exhaust manifold 18 is also connected with an exhaust conduit 20, which is further connected with a turbocharger 22. The turbocharger 22 includes therein a turbine 24 and a compressor 26, such as a centrifugal compressor. In one embodiment, a turbine wheel of the turbine 24 is coupled to compressor 26 by way of a drive shaft 28. During operation, the exhaust gases from exhaust conduit pass through the turbine 24 and cause the turbine wheel to spin, which causes the drive shaft 28 to turn, thereby causing the compressor wheel of the compressor 26 to spin. The centrifugal compressor 26 draws in air at the center of the compressor wheel and moves the air outward as the compressor wheel spins. Ambient air enters the compressor 26 through an intake 30, and compressor 26 works to compress the air so as to provide an increased mass of air to the intake manifold 16 of engine 12. The compressed air from compressor 26 is supplied to an intake air conduit 32 to transfer the fresh air to the intake manifold 16, which in turn supplies the combustion chambers of engine 12. Connected to intake air conduit 32 downstream of compressor 26 and upstream from intake manifold 16 is a charge air cooler 34. Charge air cooler 34 cools the fresh/ambient air after exiting the compressor 26 of turbocharger 22 before it enters intake manifold 16. Meanwhile, the exhaust gas supplied to the turbine 24 is discharged to the atmosphere.

Also included in internal combustion engine system 10 is an exhaust gas recirculation (EGR) system 36. The EGR system 36 is connected to exhaust conduit 20 and receives a portion of the exhaust gases generated by engine 12 to be passively routed for introduction into the intake air conduit 32 to intake manifold 16. As shown in FIG. 1, according to an embodiment of the invention, an EGR conduit 38 branches off of exhaust conduit 20 at a location downstream of the exhaust manifold 18 and upstream of the turbine 24 of turbocharger 22. An input 39 of EGR conduit 38 receives exhaust gas from exhaust conduit 20. The exhaust gas is received at input 39 and circulated through the EGR system 36 by the EGR conduit 38, which forms an exhaust path by which to transfer the gas to an outlet 41 of EGR conduit 38 and out therefrom into the intake air conduit 32 for return to the intake manifold 16 of the engine 12, thus forming an EGR circuit 43.

A portion of the exhaust gas enters into EGR system 36 through inlet 39 and is directed through EGR conduit 38 downstream to a heat exchanger 44. The heat exchanger 44 has an inlet end 46 that is in fluid communication with the exhaust manifold 18. The heat exchanger 44 cools the “hot” exhaust gas that is passed from the exhaust manifold 18 of the engine 12 using techniques that are well known in the art. The heat exchanger can be configured, for example, as a counter-flow primary surface heat exchanger, a water cooled heat exchanger, or an oil cooled heat exchanger. Upon cooling by heat exchanger 44, the “cooled” exhaust gas exits the heat exchanger 44 at an outlet end 48 for transfer to an EGR compressor 50 positioned downstream of the heat exchanger 44.

As shown in FIG. 1, a valve system 52 is positioned in the EGR conduit 38 (i.e., in the EGR circuit 43) downstream of the heat exchanger 44 to selectively cut off a flow of the exhaust gas to the EGR compressor 50 and, additionally, to selectively inject ambient air into the EGR conduit 38. During various modes of operation of internal combustion engine system 10, it is desirable to vary the intake of ambient (i.e., fresh) air and exhaust gas into the EGR compressor 50. For example, during part loads, cold start, and transient operation of the internal combustion engine system 10, it is desirable to provide an increased intake of fresh air to intake manifold 16 of engine 12. In such operational modes, the benefits of recirculating the exhaust gas back to the intake manifold 16 can be minimal (i.e., minimal emissions reductions from EGR) in comparison with the advantages of having an increased charging pressure in the intake manifold 16.

Thus, referring to FIG. 1, the valve system 52 includes a plurality of valves therein, including an EGR valve 54 positioned in EGR conduit 38 upstream of EGR compressor 50 and, according to one embodiment, downstream of heat exchanger 44. When it is desired to provide EGR compressor 50 with ambient air, EGR valve 54 is closed to block exhaust gas from flowing to the EGR compressor 50 and cut-off the flow of exhaust gas through the EGR system 36. To provide ambient air to EGR compressor 50, an air intake circuit 56 (i.e., ambient air intake conduit) having an air intake is provided to EGR system 36 and includes therein an intake valve 58 for controlling the amount of ambient air introduced into EGR system 36. In an open position, intake valve 58 allows for the injection of ambient air into the EGR system 36 through air intake path 56. While valve system 52 is shown in FIG. 1 as comprising a separate EGR valve 54 and intake valve 58, it is also recognized that a single valve could be positioned at an intersection 59 of the EGR conduit 38 and the air intake circuit 56, to control the flow of exhaust gas and injection of ambient air.

The selective opening and closing of EGR valve 54 and intake valve 58, and the corresponding termination of the flow of exhaust gas through the EGR system 36 and injection of ambient air into the EGR system 36, allows for the selective operation of EGR compressor 50 as a standard compressor and as a supercharger. That is, when EGR valve 54 is in an open position (and intake valve 58 is closed), EGR compressor 50 is supplied with exhaust gas and functions as a compressor to compress the exhaust gas for introduction into the intake manifold 16 of the engine 12. Conversely, when the intake valve 58 is an open position (and EGR valve 54 is closed), EGR compressor 50 is supplied with ambient air and functions as a “supercharger” to compress the ambient air for introduction into the intake manifold 16 of the engine 12. The operation of EGR compressor 50 as a supercharger for part loads, cold start, and transient operation of the engine 12 can provide a reduction in specific fuel consumption and an increase in volumetric efficiency of the engine, as well as improved transient and cold start behavior.

In either mode of operation, EGR compressor 50 functions to compress the exhaust gas/ambient air to an acceptable level for transfer to the intake manifold 16 according to a forced air induction intake method. To provide such forced air induction, EGR compressor 50 is configured to compress the exhaust gas/ambient air at a high pressure ratio. According to the embodiment of FIG. 1, the EGR compressor 50 is driven by an electric motor 60. Electric motor 60 is configured to operate at variable speeds/power outputs to supply a controlled power to EGR compressor 50, allowing for variable operation of the EGR compressor 50 to produce a varied compression ratio as is needed/desired by internal combustion engine system 10. According to an embodiment of the invention, a gearbox (not shown) may be included between the variable speed motor and the EGR compressor to provide for variable operation thereof.

Once the exhaust gas/ambient air is compressed a desired amount by EGR compressor 50, the exhaust gas/ambient air exits the EGR compressor 50 via EGR conduit 38. As shown in FIG. 1, EGR conduit 38 joins with the intake air conduit 32 downstream of charged air cooler 34 to mix the exhaust gas/ambient with ambient air supplied from turbocharger compressor 26. It is also envisioned, however, that EGR conduit 38 could join with the intake air conduit 32 upstream of the charged air cooler 34. Thus, the exhaust gas/ambient air circulated through EGR system 36 will be mixed with fresh intake air provided from turbocharger 22, and the mixture is transferred to intake manifold 16.

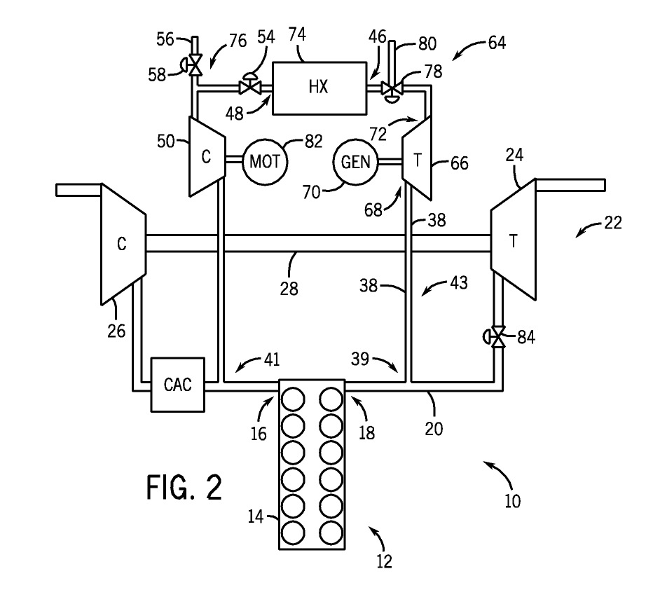

Referring now to FIG. 2, according to another embodiment of the invention, an EGR system 64 is shown and includes therein an expansion turbine 66 (i.e., expander). A portion of the exhaust gas enters into EGR system 64 through inlet 39 and is directed through EGR conduit 38 downstream to the expansion turbine 66, which receives the exhaust gas through an inlet 68 connected to EGR conduit 38. The exhaust gas received by expansion turbine 66 is at an elevated temperature, as it is received directly from exhaust manifold 18 of engine 12, and the expansion turbine 66 works to expand the exhaust gas to decrease the temperature thereof. The expansion of the exhaust gas produces work that is turned into power by the expansion turbine 66 in the form of a mechanical power output.

As shown in FIG. 2, according to one embodiment of the invention, the mechanical power output generated by expansion turbine 66 is transferred to a generator 68 that is connected thereto, such that the generator will generate electrical power. The electrical power from generator 70 can be used to power various components in the internal combustion engine system 10, including the EGR compressor 50 positioned downstream from the expansion turbine 66 (by way of an electric motor), as will be explained in greater detail below. The amount of power generated by expansion turbine 66 and transferred to generator 70 will vary according to the specific configuration of internal combustion engine system 10. This power can, however, be used to compensate for the power requirements of the motor.

Referring still to FIG. 2, after the exhaust gas is expanded and cooled by expansion turbine 66, it exits an outlet 72 of the expansion turbine and is transferred by way of EGR conduit 38 to a heat exchanger 74. The heat exchanger 74 has an inlet end 46 that is in fluid communication with the exhaust manifold 18. The heat exchanger 74 further cools the exhaust gas that is passed from the exhaust manifold 18 of the engine 12 and through the expansion turbine 66. Cooling of the “hot” exhaust gas is accomplished by the heat exchanger 74 using techniques that are well known in the art. The heat exchanger can be configured, for example, as a counter-flow primary surface heat exchanger, a water cooled heat exchanger, or an oil cooled heat exchanger. Beneficially, the size/volume of heat exchanger 74 can be significantly reduced (e.g., reduced by 50%) as compared to heat exchangers typically used in an EGR system, and as compared to the heat exchanger 44 shown in FIG. 1. That is, as the exhaust gas is cooled to an extent as it passes through the expansion turbine 66, heat exchanger 74 can be downsized, as a smaller amount of additional cooling is required thereby.

As shown in FIG. 2, a valve system 76 is positioned in the EGR conduit 38 (i.e., in the EGR circuit 43) downstream of the heat exchanger 74 to selectively cut off a flow of the exhaust gas to the EGR compressor 50 and, additionally, to selectively inject ambient air into the EGR conduit 38. During various modes of operation of the internal combustion engine system 10, it is desirable to vary the intake of ambient (i.e., fresh) air and exhaust gas into the EGR compressor 50. For example, during part loads, cold start, and transient operation of the internal combustion engine system 10, it is desirable to provide an increased intake of fresh air to intake manifold 16 of engine 12. In such operational modes, the benefits of recirculating the exhaust gas back to the intake manifold 16 may be relatively small (i.e., minimal emissions reductions from EGR) in comparison with the advantages of having an increased charging pressure in the intake manifold 16.

Thus, referring to FIG. 2, the valve system 76 includes a plurality of valves therein, including an EGR valve 54 positioned in EGR conduit 38 upstream of EGR compressor 50 and, according to one embodiment, downstream of heat exchanger 74. When it is desired to provide EGR compressor 50 with ambient air, EGR valve 54 is closed to block exhaust gas from flowing to the EGR compressor 50 and cut-off the flow of exhaust gas through the EGR system 64. To provide ambient air to EGR compressor 50, an air intake circuit 56 (i.e., ambient air intake conduit) having an air intake is provided to EGR system 64 and includes therein an intake valve 58 for controlling the amount of ambient air introduced into EGR system 64. In an open position, intake valve 58 allows for the injection of ambient air into the EGR system 64 through air intake path 56. As further shown in the embodiment of FIG. 2, valve system 76 further includes a secondary EGR valve 78 positioned to control venting of exhaust gas into a secondary exhaust path 80, which joins with EGR conduit 38 upstream of heat exchanger 74. The secondary EGR valve 78 is positioned at the intersection of EGR conduit 38 and secondary exhaust path 80, and is configured to selectively cut-off the flow of exhaust gas through the EGR system 64 and to provide venting of exhaust gas out of the EGR system 64 and into the exhaust system of the engine. That is, in a first position, secondary EGR valve 78 cuts-off the flow of exhaust gas through the EGR system 64 upstream of heat exchanger 74 and diverts the exhaust gas to the secondary exhaust path 80 and into the exhaust system of the engine so as, for example, to further treat the exhaust gas before venting to the atmosphere. In a second position, secondary EGR valve 78 allows for the flow of exhaust gas to continue through the EGR system 64.

The selective opening and closing of EGR valve 54 and intake valve 58 (and/or secondary EGR valve 78), and the corresponding termination of the flow of exhaust gas through the EGR system 64 and injection of ambient air into the EGR system 64, allows for the selective operation of EGR compressor 50 as a standard compressor and as a supercharger. That is, when EGR valve 54 is in an open position (and intake valve 58 is closed and/or secondary EGR valve 78 is in the second position), the EGR compressor 50 is supplied with exhaust gas and functions as a compressor to compress the exhaust gas for introduction into the intake manifold 16 of the engine 12. Conversely, when the intake valve 58 is an open position and EGR valve 54 is closed (and secondary EGR valve 78 is in the first position), EGR compressor 50 is supplied with ambient air and functions as a supercharger to compress the ambient air for introduction into the intake manifold 16 of the engine 12. The operation of EGR compressor 50 as a supercharger for part loads, cold start, and transient operation of the engine 12 provides a reduction in specific fuel consumption and an increase in volumetric efficiency of the engine, as well as improved transient and cold start behavior.

Upon receiving the exhaust gas/ambient air, the EGR compressor 50 functions to compress the exhaust gas/ambient air to an acceptable level for transfer to the intake manifold 16 via the forced air induction intake method. In the event that exhaust gas is transferred to EGR compressor 50, EGR compressor 50 is configured to compress the exhaust gas at a high pressure ratio. As the exhaust gas was expanded upon passage through the expansion turbine 66, the pressure of the exhaust gas requires compression work to be introduced in the intake manifold 16. The EGR compressor 50 is required to provide the compression. According to the embodiment of FIG. 2, power generated by expansion turbine 66 is used to drive the EGR compressor 50 to achieve such an increased pressure ratio. That is, power from the generator 70 is transferred to an electric motor 82, which operates at variable speeds/power outputs to supply a controlled power to the EGR compressor 50. The power provided from expansion turbine 66 is sufficient to allow for operation of the EGR compressor 50 within a large range of operating conditions. Beneficially, as the expansion turbine 66 operates independently (i.e., is decoupled) from the EGR compressor 50, the power output of expansion turbine 66 is not directly transmitted to the EGR compressor 50. Instead, the generator 70 and electric motor 82 provide for variable operation of the EGR compressor 50 independent from the expansion turbine 66, allowing the EGR compressor to operate with an increased degree of versatility and operate to produce a varied compression ratio as needed/desired by internal combustion engine system 10.

Once the exhaust gas/ambient air is compressed a target amount by the EGR compressor 50, the exhaust gas/ambient air exits the EGR compressor 50 via EGR conduit 38, and is transferred to intake air conduit 32 mix with ambient air provided by the turbocharger compressor 26 for transfer to the intake manifold 16.

As further shown in FIG. 2, an exhaust valve 84 (i.e., throttle) is included in the internal combustion engine system 10 and positioned upstream of the turbine 24 of turbocharger 22 on the exhaust conduit 20. The exhaust valve 84 provides for a controlled flow of exhaust gas to turbocharger 22 and, correspondingly, controls the amount of exhaust gas diverted to EGR system 64. When exhaust valve 84 is biased to divert a larger amount of exhaust gas to EGR system 64, an increased amount of exhaust gas is passed through the expansion turbine 66. As such, an increased amount of power is extracted from the exhaust gas by expansion turbine 66, and an increased amount of electrical power is generated by generator 70. Beneficially, the increased electrical power generated by generated 70 can be provided to electric motor 82 to power the EGR compressor 50 when it is operated as a supercharger. That is, as the energy required by the supercharger 50 to compress the ambient air to a desired pressure ratio may differ slightly from that required for compressing the exhaust gas, it is desirable to selectively generate increased power from expansion turbine 66 by diverting an increased amount of exhaust gas through the EGR system 64 via use of exhaust valve 84.

In various other embodiments, the system 10 can comprise other components such as additional valves, particulate filters, exhaust treatment devices (e.g., catalytic converters and NOₓ traps), sensors, and the like. The arrangement of these components within the system varies depending on the application and is readily understood by those in the art.

The systems and method disclosed herein reduce NOₓ emissions, while increasing the efficiency of the engine.

The invention has been described in terms of the embodiments, and it is recognized that equivalents, alternatives, and modifications, aside from those expressly stated, are possible and within the scope of the appending claims.

What is claimed is:

1. An exhaust gas recirculation (EGR) apparatus, comprising:
an EGR circuit comprising:
an input configured to receive an exhaust gas from an engine exhaust port;
an output configured to return the exhaust gas to an intake port of the engine; and
an EGR path configured to circulate the exhaust gas between the input and the output;
an EGR compressor connected to the EGR circuit in the EGR path downstream of the input, the EGR compressor configured to compress the exhaust gas for circulation to the output; and
a valve system positioned in the EGR circuit and upstream of the EGR compressor to selectively cut off a flow of the exhaust gas to the EGR compressor and selectively inject ambient air into the EGR path.

2. The EGR apparatus of claim 1, wherein the EGR circuit further comprises an air intake path having:
an air intake configured to intake the ambient air; and
an air output coupled to the EGR path upstream of the EGR compressor.

3. The EGR apparatus of claim 2, wherein the valve system comprises:
an intake valve positioned in the air intake path to control injection of the ambient air into the EGR path; and
an EGR valve positioned in the EGR path upstream of the air output of the air intake path to control a flow of the exhaust gas to the EGR compressor.

4. The EGR apparatus of claim 3, wherein, when the intake valve is an open position to inject the ambient air into the EGR path and the EGR valve is in a closed position to cut off the flow of the exhaust gas to the EGR compressor, the EGR compressor is configured to operate as a supercharger.

5. The EGR apparatus of claim 3, wherein the valve system further comprises a secondary EGR valve positioned upstream of the EGR valve, the secondary EGR valve configured to selectively control a flow of the exhaust gas through the EGR path and selectively vent exhaust gas out from the EGR path.

6. The EGR apparatus of claim 1, further comprising an exhaust valve positioned upstream of the valve system to control a flow of the exhaust gas into the EGR circuit.

7. The EGR apparatus of claim 1, further comprising an expansion turbine connected to the EGR circuit in the EGR path downstream of the input and upstream of the valve system, the expansion turbine configured to receive and expand the exhaust gas to reduce a pressure thereof.

8. The EGR apparatus of claim 7, further comprising:
a generator connected to the expansion turbine, the expansion turbine configured to drive the generator to generate electrical power; and
an electric motor connected to the generator, the electric motor configured to receive the electrical power generated by the generator and to drive the EGR compressor.

9. The EGR apparatus of claim 8, wherein the electric motor comprises a variable speed motor to selectively drive the EGR compressor to pressurize the exhaust gas to a desired level.

10. An engine system, comprising:
an engine having an intake manifold and an exhaust manifold;
an exhaust conduit connected to the exhaust manifold to convey an exhaust gas away from the engine;
a turbocharger having a turbine and a compressor driven by the turbine, wherein the turbine is connected to the exhaust conduit to receive the exhaust gas from the exhaust manifold, and wherein the compressor is positioned upstream of, and connected to, the intake manifold; and
an exhaust gas recirculation (EGR) system connected to the exhaust conduit to receive at least a portion of the exhaust gas from the exhaust conduit, the EGR system comprising:
an EGR conduit connected to the exhaust conduit to receive the at least a portion of the exhaust gas;
a valve system positioned in the EGR conduit to control a flow of the at least a portion of the exhaust gas through the EGR conduit and selectively inject ambient air into the EGR conduit; and
an EGR compressor connected to the EGR conduit downstream of the valve system and configured to selectively operate as a supercharger based on an orientation of the valve system.

11. The engine system of claim 10, wherein the EGR system further comprises an ambient air intake conduit positioned upstream of the EGR compressor and downstream of the expander to introduce ambient air into the EGR conduit.

12. The engine system of claim 11, wherein the valve system further comprises:
an intake valve positioned in the ambient air intake conduit and configured to control injection of the ambient air into the EGR conduit; and
an EGR valve positioned in the EGR conduit and upstream of the ambient air intake conduit and configured to control a flow of the at least a portion of the exhaust gas to the EGR compressor.

13. The engine system of claim 12, wherein when the EGR valve is in a closed position and the intake valve is in an open position to provide ambient air to the EGR compressor, the EGR compressor operates as a supercharger configured to compress the ambient air.

14. The engine system of claim 13, wherein the EGR compressor operates as the supercharger during operation of the engine in one of a part load, a cold start, and a transient state.

15. The engine system of claim 10, further comprising an exhaust valve positioned in the exhaust conduit upstream of the turbine to selectively control a flow of another portion of the exhaust gas to the turbocharger turbine.

16. The engine system of claim 10, further comprising an expansion turbine connected to the EGR conduit upstream of the valve system, the expansion turbine configured to receive and expand the at least a portion of the exhaust gas to reduce a pressure thereof.

17. The engine system of claim 16, further comprising:
a generator connected to the expansion turbine, the expansion turbine configured to drive the generator to generate electrical power; and
an electric motor connected to the generator and configured to receive the electrical power therefrom and drive the EGR compressor.

18. A method, comprising:
conveying exhaust gas from an exhaust manifold of an internal combustion engine to an exhaust gas recirculation (EGR) system;
selectively terminating a flow of the exhaust gas through the EGR system at a location upstream from an EGR compressor in the EGR system;
selectively injecting ambient air into the EGR system at a location upstream from the EGR compressor in the EGR system;
selectively transferring one of the exhaust gas and the ambient air to the EGR compressor;
compressing the one of the exhaust gas and the ambient air to a desired pressure in the EGR compressor; and
recirculating the compressed one of the exhaust gas and the ambient air to an intake manifold of the internal combustion engine.

19. The method of claim 18, wherein selectively terminating the flow of the exhaust gas through the EGR system comprises actuating an EGR valve between an open position and a closed position to selectively cut-off the flow of the exhaust gas through the EGR system at the location upstream from the EGR compressor.

20. The method of claim 18, wherein selectively injecting ambient air into the EGR system comprises actuating an air intake valve between an open position and a closed position to selectively inject ambient air into the EGR system at a location upstream from the EGR compressor.

21. The method of claim 18, further comprising expanding the exhaust gas in an expansion turbine in the EGR system positioned upstream of the EGR compressor to lower a temperature and to generate a mechanical power output.

22. The method of claim 21, further comprising:
driving a generator connected to the expansion turbine with the mechanical power output;
supplying electrical power from the generator to an electric motor; and
driving the EGR compressor with the electric motor.
